(19) United States
(12) Patent Application Publication
(10) Pub. No.: US 2007/0203614 A1
(43) Pub. Date: Aug. 30, 2007

(54) Device Comprising A Unit For Actuating A Variable Drive Unit Of A Motor Vehicle

(75) Inventor: Jochen Strenkert, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler, Stuttgart (DE)

(21) Appl. No.: 10/584,126

(22) PCT Filed: Nov. 23, 2004
(86) PCT No.: PCT/EP04/13263

§ 371 Date: May 10, 2007

(30) Foreign Application Priority Data
Dec. 23, 2003 (DE) 103 60 640.8

(51) Int. Cl. G06F 17/00

(52) U.S. Cl. 701/1

(57) ABSTRACT

A vehicle control device activates an adjustable drive unit of a motor vehicle dependent upon at least one control signal. In a constant driving mode, a virtual control signal is created and used instead of the real control signal for activating the drive unit.

### BACKGROUND AND SUMMARY OF THE INVENTION

This application claims the priority of German patent document 103 60 640.8, filed Dec. 23, 2003 (PCT International Application No. PCT/EP2004/013263, filed Nov. 23, 2004), the disclosure of which is expressly incorporated by reference herein.

The invention concerns a device with a unit for activating an adjustable drive unit of a motor vehicle.

Published U.S. Patent Application No. 2001/0056009 A1 discloses a device with a unit which is equipped so that an adjustable drive unit of a motor vehicle is activated dependent upon at least one control signal, which represents an adjustable angle of a gas pedal. At least in one phase, a virtual control signal is produced and used instead of the real control signal, for activating the drive unit. In this phase, propulsion of the motor is adjusted, so that a constant separation is maintained to a vehicle traveling in front of the motor vehicle.

One object of the invention is to provide a generic device which implements a constant travel desire of the driver, in a comfortable manner.

This and other objects and advantages are achieved by the control arrangement according to the invention, which includes a unit that is equipped so that an (especially continuously) adjustable drive unit of a motor vehicle is activated dependent upon at least one control signal, and in at least one phase, a virtual control signal is generated and used instead of a real control signal for activating the drive unit. According to the invention, the unit is equipped so that the drive unit is activated (at least in a constant drive mode, in which the unit generates a constant driving force of the motor vehicle through a suitable choice of the control signal) dependent upon the virtual control signal. In this manner, in the constant drive mode, small deviations from the actual control signal (i.e., the signal produced by the driver of the motor vehicle, indicating a course of the control signal desired by the driver of the motor vehicle and anticipated by the unit) do not lead to an adjustment of the drive unit, especially when the deviations are infrequent. Small deviations of the control signal from the desired course based on the constant drive desire of the driver can be recognized as unwanted and ignored, so that the driver can have a comfortable driving experience. Moreover by a suitable choice of a course of the virtual control signal, advantages can be achieved with regard to both fuel consumption in the constant drive mode, and long service life of the drive unit. By anticipating the time course of the control signal determined by the constant drive desire of the driver, this can be carried out more precisely using the virtual control signal, than is possible by a driver.

A time course of a control signal desired by the driver can be anticipated reliably in the constant drive mode especially simply and advantageously. An especially simple control and/or regulating logic of the drive unit can be achieved if the constant drive mode differs from other operating modes only in the use of the virtual control signal instead of the real control signal. An operating mode of the motor vehicle in which, by a suitable choice of the control signal, the unit sets up a substantially constant propelling power of the motor vehicle, should be designated as constant drive mode. Thereby it can come to an acceleration or to a deceleration of the motor vehicle dependent upon a driving resistance.

The drive unit can be, for example, a motor with adjustable throttle valves, a drive, a clutch, or another known adjustable unit with an influence on the drive train of the motor vehicle. Due to the sensitivity of such units relative to small fluctuations in the control signal there are special advantages relative to comfort if the drive unit of the motor vehicle is continuously variable. The real control signal can be given by any characteristic magnitude with an influence upon an activation of the drive train, as known to those skilled in the art, which is adjustable by a driver. Due to its direct effect, however, the invention is especially advantageously adjustable if the control signal represents an adjustment of a gas pedal or an adjustment angle of a gas pedal.

The unit can be made as a single part or multiple parts with the drive unit. By “provided” in this connection “laid out” and “equipped” should also be understood.

The control signal designated as “virtual” should be mechanically produced and at least substantially independent of the actual course of the real control signal produced by the driver. At least a characteristic magnitude (for example an rpm of the drive unit) should be uncoupled in the phase of the real control signal and be determined by the virtual control signal.

The virtual control signal can be produced by the unit itself or by a sub-unit, for example a computer unit.

An especially quiet driving sensation in the constant driving mode can be achieved if the unit is provided for determining a constant virtual control. There are however also other time courses of the virtual control signal, that are known to those skilled in the art, which may be considered.

If the unit is configured to determine the virtual control signal dependent upon a real control signal at a switch on point of the constant drive mode, advantageously an adaptation of the constant drive mode to the circumstance leading to the switching on of the constant drive mode can be achieved.

If the virtual control signal is equal to the real control signal at the switching on point, the switch on point in time can become barely perceptible by the driver. In particular, it can be avoided that the driver gets a feeling of lack of control of the motor vehicle.

If the unit for switching on and switching off the constant drive mode is dependent upon the time course of a real control signal, the driver can exercise a full control over the motor vehicle by means of the control signal. Thereby an acceleration or braking desire of the driver can be acknowledged if the unit is equipped to switch off the constant drive mode when the real control signal exceeds a set interval. Advantageously, the interval can be adaptable to the long or medium term driving behavior of the driver, and its average point can be determined by an average point of the real control signal.

If the unit is equipped to switch off the constant driving mode when a rate of change of the real control signal exceeds a preset range, it is possible to achieve an especially fast reaction of the unit to an acceleration or braking wish of the driver.

Analogous criteria for switching off the constant driving mode can advantageously be formulated relative to the time course of the speed of the motor vehicle and/or a driving resistance.

If the unit for activating the motor vehicle engine is dependent upon a discontinuous control signal upon switching off the constant driving mode, the driver can experience an especially spontaneous driving feeling. In particular, if a unit for activating a continuous drive is provided, it can recognize an acceleration desire, and abruptly reduce a translation whereby a torque reserve of a motor is abruptly increased, which is perceived by the driver as spontaneous downshifting. There are also however arrangements of the invention to be considered in which the unit smoothes the discontinuity in a way, for example, that is dependent upon a driver's profile.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a motor vehicle with a continuously variable drive unit, a gas pedal and a unit for activating the drive unit dependent upon a control signal from the gas pedal;

FIG. 2 is a flow chart that illustrates a process for activating the drive unit from FIG. 1, in a constant driving mode and in a normal mode;

FIG. 3 is a decision diagram of the process in FIG. 2; and

FIG. 4 is a graphic depiction of the time variation of a real control signal and a virtual control signal.

### DETAILED DESCRIPTION OF THE DRAWINGS

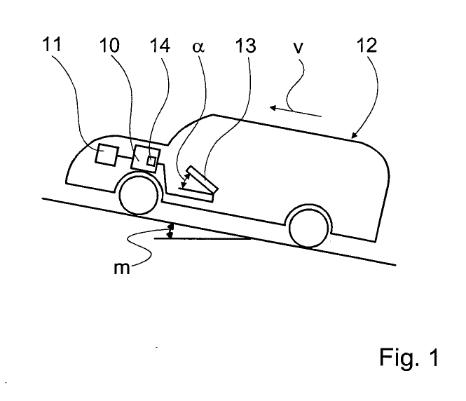

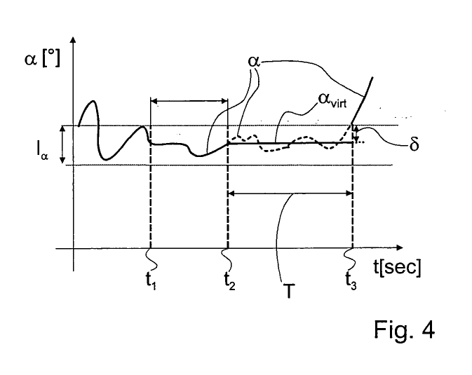

FIG. 1 shows a motor vehicle 12 with a unit 10 which can activate an adjustable drive unit 11 (formed in the illustrated example as a continuously variable drive), dependent upon a real control signal a and upon a virtual control signal aᵥᵢᵣₜ. The unit 10 is equipped to recognize a constant drive desire of a driver, and to switch on a constant drive mode supporting this desire dependent upon a time course of the real control signal a during a phase T, and to switch it off (FIG. 4) at the end of the phase T. The real control signal a represents an adjustment angle of a gas pedal 13, includes a sensor integrated into the gas pedal 13, and can read the unit 10 over a CAN interface from a CAN bus of the motor vehicle 12. Moreover the unit 10 is so designed as to acquire additional characteristic values of the motor vehicle 12, for example velocity v, acceleration, engine rpm, and a throttle valve angle of a motor vehicle, through the CAN interface. A computer unit 14 of the unit 10 is equipped to calculate a driving resistance from the acceleration, the throttle valve angle, and the velocity v and to issue this as a characteristic value for a highway rise m.

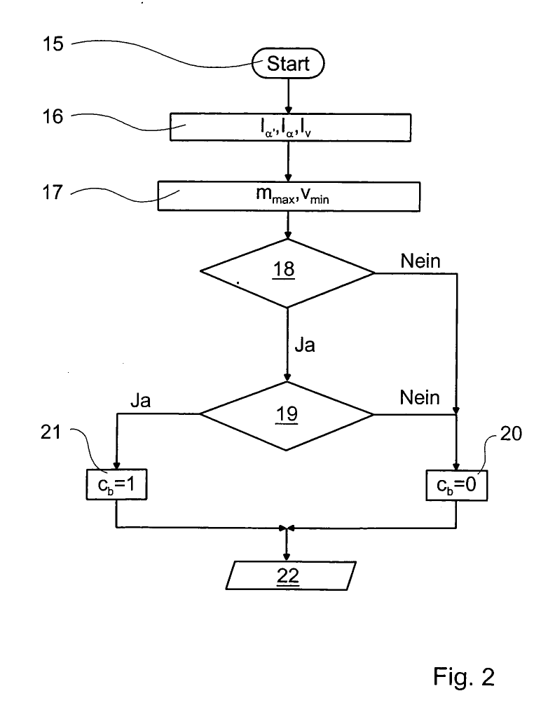

The program for recognizing a constant driving desire (FIG. 2) sets a control bit c_{b} to 1 upon recognizing a constant driving desire, and otherwise to 0. After an initialization 15, in an interval determination step 16 the unit 10 determines the width and centers of gravity of intervals Iₐ, Iᵥ, Iₐ′ within which the speed v and the control signal a and a change velocity a′ of the control signal a must necessarily vary in order for the unit 10 to recognize the occurrence of a constant driving wish. The centers of gravity of the intervals Iₐ, Iᵥ, Iₐ′ are an equalizing means over a pre-adjusted time interval of the respective values a, a′, v and the width of the intervals Iₐ, Iᵥ, Iₐ′ are determined by the variance of the respective values a, a′, v. In a threshold value determination (step 17) threshold values stored in a memory unit of the unit 10, as well as a maximum value mₘₐₓ and minimum speed vₘᵢₙ, are read out.

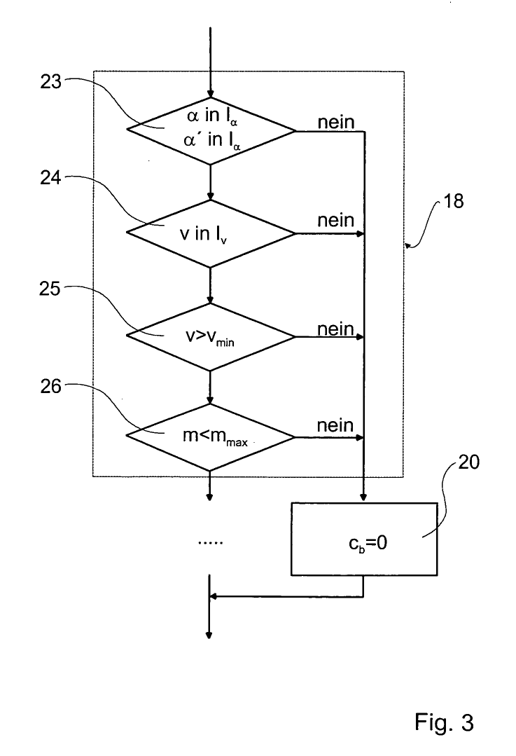

In a decision block 18 (which is represented in detail in FIG. 3), the unit 10 checks whether constant driving conditions are met. If so, the unit increments a time measurement counter. If not all constant driving conditions are met, in a step 20 the unit 10 sets the time measurement counter and the control bit c_{b} to 0. After the incrementing of the time measurement counter the unit 10 checks (step 19) whether the time measurement counter has exceeded a stored critical value. Since the decision block 18 will always run in elementary time intervals, the value of the time measurement counter is proportional to the duration τ′ over which time all constant driving conditions are met. If the duration τ′ is longer than an applicable value τ, in a step 21 the unit 10 sets the control bit c_{b} to 1, sets the virtual control signal aᵥᵢᵣₜ to the actual value of the control signal a and switches the constant driving mode on, whereby the phase T begins. If the time period τ′ is shorter than the value τ then the unit 10 sets the control bit c_{b} in step 20 to 0. In an output step 22 the unit 10 finally outputs the control bit c_{b}.

As shown in FIG. 3, in the decision block 18, the unit 10 checks in a first step 23 whether the control signal a lies in the interval Iₐ, and whether the change speed a′ of the real control signal a lies within the corresponding interval Iₐ′ (FIG. 3). If so, the unit 10 then checks in a second step 24 whether the speed v of the motor vehicle 12 lies within the interval Iᵥ. If so, the unit 10 checks in a step 25 whether the speed v (FIG. 1) of the motor vehicle 12 is greater than a minimum speed vₘᵢₙ and in a step 26, whether the highway upward grade m (FIG. 1) is less than a maximum value mₘₐₓ, whether a speed governing function of the motor vehicle 12 is turned off, and whether the drive unit 11 is switched on to a forward travel position. If one of the conditions checked in steps 23-26 is not met, in step 20 the unit 10 sets the control bit c_{b} to 0. If all of the conditions checked in steps 23-36 are met, the program jumps to step 19 (FIG. 2).

In the constant driving mode the unit 10 uses the virtual control signal aᵥᵢᵣₜ instead of the real control signal a. If while the constant driving mode is turned on (c_{b}=1), in a run through the decision block 18 one of the conditions checked in the steps 23-26 is no longer met, in the step 20 the unit 10 sets the control bit c_{b} and the time measurement counter to 0, the constant driving mode is then switched off, and the phase T ends. In connection therewith, the unit 10 activates the drive unit 11 so that it is once again dependent upon the real control signal a, and upon switching off the constant drive mode the control signal selected from the control signal aᵥᵢᵣₜ, a, dependent on which the unit 10 activates the drive unit 11, varies with time.

The time course of the real control signal a and of the virtual control signal aᵥᵢᵣₜ based on which the unit 10 activates the drive unit 11, are shown in FIG. 4, each being represented as drawn through lines. At a point in time t₁ in the step 20 the unit 10 sets the control bit c_{b} and the time measurement counter to 0. Thereafter, at time t₂, all of the conditions checked in steps 23-25 are fulfilled and the unit 10 increments the time measurement counter until the time duration τ′, over which all constant driving mode conditions are met, until the value τ is reached, and in the step 21 the unit 10 sets the control bit c_{b} to 1, the virtual control signal aᵥᵢᵣₜ to the value of the real control signal a assigned to even this time point τ₂, and the constant driving mode switched on. The phase T in which the drive unit 11 is decoupled from the real control signal a, begins at time t₂. At a time t₃ the real control signal a exceeds the interval Iₐ, so that the condition checked in step 23 is no longer met, and in step 20 the unit 10 sets the control bit c_{b} to 0 and switches off the constant driving mode. At the time point t₃ the selected control signal a, aᵥᵢᵣₜ, dependent on which the unit 10 activates the drive unit 11, ends discontinuously and jumps by a difference δ between the virtual control signal aᵥᵢᵣₜ and the real control signal a.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Apparatus for controlling activation of an adjustable drive unit of a motor vehicle dependent upon at least one control signal; wherein:
at least during a constant driving mode a virtual control signal is generated in addition to a real control signal, for activating the drive unit;
during the constant driving mode the drive unit is activated dependent upon the virtual control signal instead of the real control signal: and
during the constant driving mode, the apparatus maintains a constant driving force of the motor vehicle through an appropriate selection of the control signals.

2. The apparatus according to claim 1, wherein a unit for determining a constant virtual control signal is provided.

3. The apparatus according to claim 2, wherein determination of the virtual control signal depends upon a real control signal at a switch on point (t₂) of the constant driving mode.

4. The apparatus according to claim 3, wherein the virtual control signal at the switch on point is equal to the real control signal.

5. The apparatus according to claim 4, wherein the unit switches the constant driving mode on and off, dependent upon a time course of a real control signal.

6. The apparatus according to claim 5, wherein the unit is switches the constant driving mode off when the real control signal exceeds a set interval.

7. The apparatus according to claim 1, wherein the unit switches the constant driving mode off when the speed change rate of the real control signal exceeds a set an interval.

8. (canceled)

9. The apparatus according to claim 1, wherein said drive unit is continuously adjustable.
